(19) United States
(12) Patent Application Publication
(10) Pub. No.: US 2012/0113226 A1
(43) Pub. Date: May 10, 2012

(54) 3D IMAGING DEVICE AND 3D REPRODUCTION DEVICE

(75) Inventors: Keisuke Nakata, Osaka (JP); Makoto Takano, Shiga (JP)

(73) Assignee: Panasonic Corporation, Osaka (JP)

(21) Appl. No.: 13/287,129

(22) Filed: Nov. 2, 2011

(30) Foreign Application Priority Data
Nov. 4, 2010 (JP) 2010-247069
Oct. 11, 2011 (JP) 2011-224095

(51) Int. Cl. H04N 13/02; G06T 15/00

(52) U.S. Cl. 348/46; 345/419; 348/E13.074

(57) ABSTRACT

A 3D imaging device is provided that includes an identification unit, a parallax information decision unit, a display position decision unit, and a 3D display control unit. The identification unit calculates parallax information with respect to an object image based on a first image signal and a second image signal. The identification unit also sets identification information for identifying an object image. The identification unit further outputs first parallax information and identification information. The parallax information decision unit decides on second parallax information based on first parallax information so that identification information is visually recognizable at a depth separate from the object image. The 3D display control unit is coupled to at least one of the identification unit, the parallax information decision unit, and the display position decision unit. The 3D display control unit displays identification information superimposed on the first second image signals based on second parallax information.

### CROSS-REFERENCE TO RELATED APPLICATIONS

This application claims priority to Japanese Patent Application No. 2010-247069, filed on Nov. 4, 2010 and Japanese Patent Application No. 2011-224095, filed on Oct. 11, 2011. The entire disclosure of Japanese Patent Application No. 2010-247069 and Japanese Patent Application No. 2011-224095 are hereby incorporated herein by reference.

### BACKGROUND

1. Technical Field

The technology disclosed herein relates to a 3D imaging device and a 3D reproduction device, and more particularly relates to a 3D imaging device and a 3D reproduction device having a facial identification function.

2. Background Information

It is known that a three-dimensional (3D) image signal can be reproduced with a display device. Left and right images captured with binocular parallax are projected independently at the left and right eyes by the display device. The standard method for acquiring left and right images is to set up two independent cameras side by side and capture images in synchronization, or to capture subject images at separate perspectives formed based on two optical systems.

Meanwhile, technology for performing facial identification (personal identification) is known (see, for example, Japanese Laid-Open Patent Application 2007-150601). Here, characteristic points of a person's face are extracted based on a photographic image of the person's face, and facial identification is performed based on the agreement between these characteristic points and facial identification data related to the person to be identified.

With a conventional imaging device which is capable of facial identification, information associated with a subject was displayed based on an image signal obtained by two-dimensional imaging. However, a method in which the display position of the above-mentioned information is decided based on an image signal obtained by 3D imaging has not been investigated. For instance, with a two-dimensional image corresponding to a two-dimensional image signal, the display positions of names and so forth were set near the region of the face that underwent facial identification, in a two-dimensional plan view. However, a 3D image corresponding to a 3D image signal is defined by three-dimensional space. Accordingly, with a 3D image, the display positions of names and so forth could not be decided with just a two-dimensional plan view as was the case with a two-dimensional image.

### SUMMARY

The present technology was conceived in light of the above problem, and it is one object thereof to provide an imaging device in which information associated with a subject can be displayed at a suitable position with respect to a 3D image signal.

The present technology relates to a 3D imaging device that is configured to display a 3D image of a subject based on a first image signal and a second image signal which constitutes a 3D image signal. The 3D imaging device disclosed herein comprises an identification unit, a parallax information decision unit, a display position decision unit, and a 3D display control unit. The identification unit is configured to calculate first parallax information for an object image that corresponds to the subject based on the first and second image signals. The identification unit is also configured to set identification information that identifies the object image. The identification unit is further configured to output the first parallax information and the identification information. The parallax information decision unit is configured to decide on second parallax information for the identification information based on the first parallax information so that the identification information is visually recognizable at a depth separate from the object image. The display position decision unit is configured to decide on first and second display positions of the identification information. The first display position is chosen with respect to the first image signal, and the second display position is chosen with respect to the second image signal. Selection of the first and second display positions is based on the second parallax information. The 3D display control unit is coupled to at least one of the identification unit, the parallax information decision unit, and the display position decision unit. The 3D display control unit is configured to display the identification information at the first and second display positions. At the first display position, the identification information is superimposed on the first image signal, and at the second display position, the identification information is superimposed on the second image signal.

These and other objects, features, aspects and advantages of the technology disclosed herein will become apparent to those skilled in the art from the following detailed description, which, taken in conjunction with the annexed drawings, discloses a preferred and example embodiments of the present invention.

### BRIEF DESCRIPTION OF THE DRAWINGS

Referring now to the attached drawings, which form a part of this original disclosure:

FIG. 1 is a schematic diagram of a digital camera 1 in an embodiment;

FIG. 2 is a flowchart illustrating an image signal capture operation with the digital camera 1;

FIG. 3 is a flowchart illustrating the imaging operation in 2D imaging mode;

FIG. 4 is a flowchart illustrating the imaging operation in 3D imaging mode;

FIG. 5 shows how the entire region of an image signal is divided up into sub-regions;

FIG. 6 is a flowchart illustrating the reproduction of a compressed image signal with the digital camera 1;

FIG. 7 is a diagram illustrating facial identification imaging in 2D imaging mode;

FIG. 8 is a diagram illustrating facial identification imaging in 3D imaging mode;

FIG. 9 is a flowchart illustrating the operation of a facial identification function in 3D imaging mode with the digital camera 1;

FIG. 10 is a flowchart illustrating the operation of a facial identification function in 3D reproduction mode with the digital camera 1;

FIG. 11 is a schematic showing the positional relation between an identified face and an identification name; and

FIG. 12 shows how identification names are displayed superimposed with a first perspective signal and a second perspective signal.

### DETAILED DESCRIPTION OF EMBODIMENTS

Selected embodiments of the present technology will now be explained with reference to the drawings. It will be apparent to those skilled in the art from this disclosure that the following descriptions of the embodiments of the present technology are provided for illustration only and not for the purpose of limiting the invention as defined by the appended claims and their equivalents.

### First Embodiment

A first embodiment disclosing how the present technology is applied to a digital camera will now be described through reference to the drawings.

1. Configuration of Digital Camera

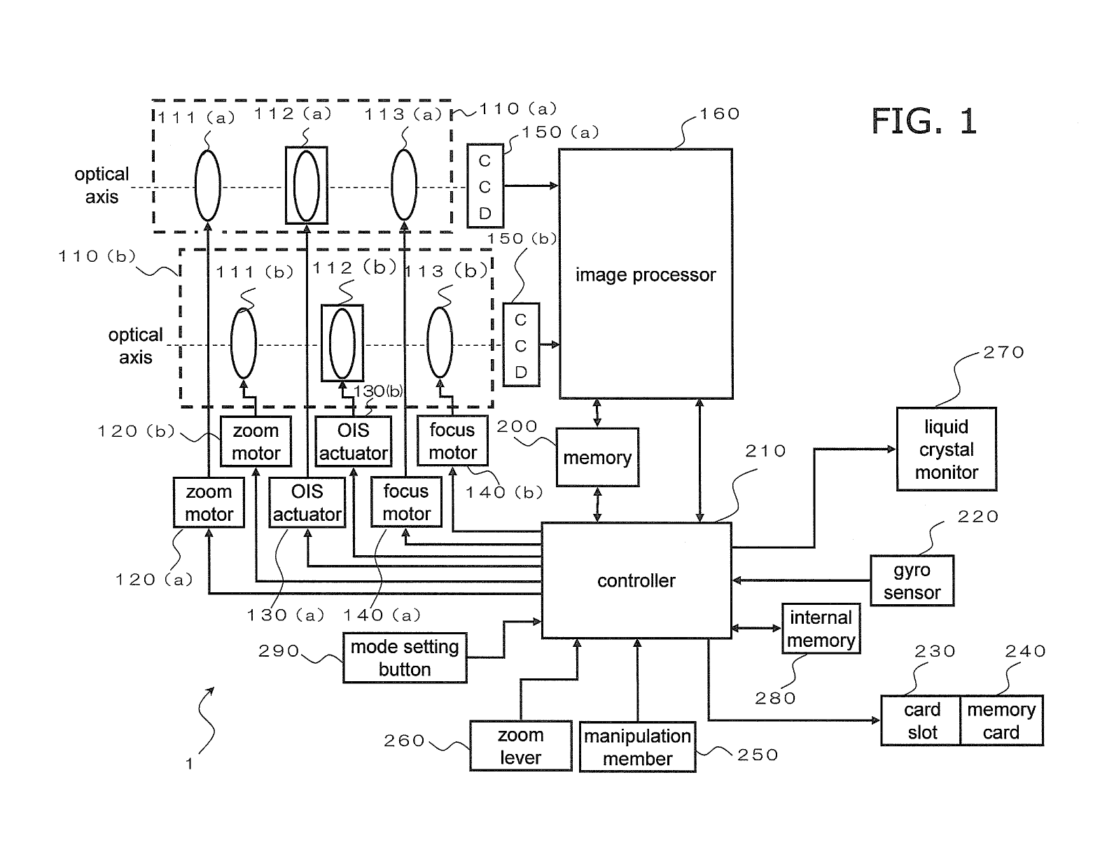

First, the configuration of the digital camera will be described. FIG. 1 is a schematic diagram of a digital camera 1 in an embodiment.

The electrical configuration of the digital camera 1 pertaining to this embodiment will be described through reference to FIG. 1. FIG. 1 is a block diagram of the configuration of the digital camera 1. The digital camera 1 comprises optical systems 110(a) and 110(b), zoom motors 120(a) and 120(b), OIS actuators 130(a) and 130(b), focus motors 140(a) and 140(b), and CCD image sensors 150(a) and 150(b). The digital camera 1 further comprises an image processor 160, a memory 200, a controller 210, a gyro sensor 220, a card slot 230, and a memory card 240. The digital camera 1 further comprises a manipulation member 250, a zoom lever 260, a liquid crystal monitor 270, an internal memory 280, and a mode setting button 290.

The optical system 110(a) includes a zoom lens 111(a), an OIS 112(a), and a focus lens 113(a). The optical system 110(b) includes a zoom lens 111(b), an OIS 112(b), and a focus lens 113(b). The optical system 110(a) forms a subject image corresponding to a subject viewed from a first perspective. The optical system 110(b) forms a subject image corresponding to a subject viewed from a second perspective. The second perspective here is different from the first perspective.

The zoom lenses 111(a) and 111(b) move along the optical axis of the optical systems, which enlarges or reduces the subject image formed at the CCD image sensors 150(a) and 150(b). The zoom lenses 111(a) and 111(b) are controlled by zoom motors 120.

The OIS's 112(a) and 112(b) have internal correction lenses that can move in a plane that is perpendicular to the optical axis. The OIS's 112(a) and 112(b) reduce blurring of the subject image by moving the correction lenses in a direction that cancels out shake of the digital camera 1. The correction lenses are able to move from the center within the OIS's 112(a) and 112(b).

The focus lenses 113(a) and 113(b) move along the optical axis of the optical systems, which adjusts the focus of the subject image formed at the CCD image sensors 150(a) and 150(b). The focus lenses 113(a) and 113(b) are controlled by a focus motor 140.

The optical systems 110(a) and 110(b) will be collectively referred to below simply as optical systems 110. The same will sometimes apply to the zoom lenses 111, the OIS's 112, the focus lenses 113, the zoom motors 120, the OIS actuators 130, the focus motors 140, and the CCD image sensors 150.

The zoom motors 120 drive and control the zoom lenses 111(a) and 111(b). The zoom motors 120 may be made up of a pulse motor, a DC motor, a linear motor, a servo motor, or the like. For example, the zoom motors 120 drive the zoom lenses 111(a) and 111(b) while synchronizing them with each other. The zoom motors 120 may drive the zoom lenses 111(a) and 111(b) via a cam mechanism, a ball screw, or another such mechanism (not shown).

The OIS actuators 130 drive and control the correction lenses in the OIS's 112(a) and 112(b) within a plane that is perpendicular to the optical axis. The OIS actuators 130 are made up of a planar coil, an ultrasonic motor, or the like.

The focus motors 140 drive and control the focus lenses 113(a) and 113(b). The focus motors 140 are made up of a pulse motor, a DC motor, a linear motor, a servo motor, or the like, for example. The focus motors 140 may drive the focus lenses 113(a) and 113(b) via a cam mechanism, a ball screw, or another such mechanism (not shown).

The CCD image sensors 150(a) and 150(b) capture the subject image formed by the optical systems 110(a) and 110(b), and produce a first perspective signal and a second perspective signal. The CCD image sensors 150(a) and 150(b) perform various operations, such as exposure, transfer, an electronic shuttering. The terms “first perspective signal” and “second perspective signal” are sometimes used in the meaning of video data or image data.

The image processor 160 performs various kinds of processing for the first perspective signal and second perspective signal produced by the CCD image sensors 150(a) and 150(b). As a result of this processing, the image processor 160 produces image data for displaying on the liquid crystal monitor 270 (hereinafter referred to as a review image), or produces an image signal for storing on the memory card 240. For example, the image processor 160 performs gamma correction, white balance correction, scratch correction, and various other kinds of image processing for the first perspective signal and the second perspective signal,.

Also, the image processor 160 performs edge enhancement processing or other such enhancement processing for the first perspective signal and the second perspective signal based on a control signal from the controller 210.

Further, the image processor 160 compresses the first perspective signal and second perspective signal processed as above by using a compression format based on the JPEG standard, for example. The compressed image signals obtained by compressing the first perspective signal and second perspective signal are associated with each other and recorded to the memory card 240. In the recording of these two compressed image signals, it is preferable to use an MPO file format for the recording. MPO stands for multi-picture object. Also, if the first perspective signal and second perspective signal are moving pictures, the first perspective signal and second perspective signal are compressed based on H.264/AVC or another such moving picture compression standard. Also, an MPO file format and a JPEG image and/or MPEG moving picture may be recorded simultaneously.

The image processor 160 can be implemented by a DSP, a microprocessor, or the like. The resolution of the review image may be set to the screen resolution of the liquid crystal monitor 270, or may be set to the resolution of the image data compressed by a compression standard that conforms to the JPEG standard, etc.

The memory 200 functions as the working memory for the image processor 160 and the controller 210. The memory 200, for example, temporarily stores image data inputted from the CCD image sensors 150 prior to processing by the image processor 160, and/or the image signal processed by the image processor 160. Also, the memory 200 temporarily stores data related to the imaging conditions of the CCD image sensors 150(a) and 150(b) and the optical systems 110(a) and 110(b). Data related to imaging conditions is data indicating the subject distance, image angle information, the ISO sensitivity, the shutter speed, the EV value, the F value, the distance between lenses, the imaging time, the OIS shift amount, and so forth. The memory 200 is a DRAM, a ferroelectric memory, or the like.

The internal memory 280 is constituted by a flash memory, a ferroelectric memory, or the like. The internal memory 280 stores control programs for controlling the digital camera 1, information related to a standard face used in facial detection, information related to faces used for facial identification, and so forth. For example, information related to a standard face used in facial detection includes information related to the position of various parts (eyes, nose, mouth, etc.) of a standard face. Information related to faces used for facial identification includes information related to the position and positional relation of various parts of the face (eyes, nose, mouth, etc.) (hereinafter referred to as first specification information).

The word “information” as used herein will sometimes be used in the sense of information data. The word “position” here will sometimes be used in the sense of position data, coordinate data, and/or distance data.

The controller 210 is a control unit for controlling the digital camera 1. The controller 210 can be implemented by a semiconductor element or the like. The controller 210 may be constituted by hardware alone, or a combination of hardware and software. The controller 210 can be implemented by a microprocessor or the like.

The controller 210 detects a face included in an image indicating the image data produced by the image processor 160. More specifically, the internal memory 280 stores information about the positions of the various parts included in the face of a standard person, etc. (the position of the eyes, the position of the nose, the position of the mouth, etc.). The controller 210 determines whether or not a portion that is similar to the information related to the positions of the eyes, nose, mouth, etc., stored in the internal memory 280 is present in an image indicating image data produced by the image processor 160. If the controller 210 determines that the above-mentioned portion is present, then the controller 210 detects as a face the specific region that includes this portion.

The word “similar” used in this embodiment encompasses a case in which two pieces of information coincide completely, and a case in which two pieces of information coincide with a predetermined range. For instance, the phrase “two pieces of information are similar” means that “two pieces of information coincide within a predetermined range of error.”

Also, the controller 210 identifies whether or not the facial image of a subject included in an image indicating image data produced by the image processor 160 is the same as a facial image recorded to the internal memory 280. More specifically, the controller 210 first detects a facial image included in an image indicating image data produced by the image processor 160. Then, the controller 210 extracts information indicating the characteristics of the facial image (hereinafter referred to as second specification information) based on the positions of the various parts (eyes, nose, mouth, etc.) included in a facial image when that facial image has been detected. The second specification information has, for example, position information about the various parts (eyes, nose, mouth, etc.) included in a facial image, relative position information between one part and another part, and so forth. Here, coordinate information is included in position information, and distance information is included in relative position information.

The controller 210 then determines whether or not this second specification information is similar to the first specification information recorded to the internal memory 280. Here, if the controller 210 has decided that the two sets of information are similar, then the controller 210 identifies the detected facial image is as same as the facial image recorded to the internal memory 280. The controller 210 therefore acquires an identification name (an example of identification information) corresponding to this face. An identification name is a person's name, etc., corresponding to a facial image recorded to the internal memory 280. The identification name is associated with the facial image and recorded to the internal memory 280. On the other hand, if the controller 210 determines that the detected facial image is not similar to the facial image recorded to the internal memory 280, then the controller 210 identifies the detected facial image as being a different facial image (an unrecorded facial image) from the facial image recorded to the internal memory 280.

The gyro sensor 220 is constituted by a piezoelectric element or another such vibrating member. The gyro sensor 220 obtains angular velocity information by vibrating the piezoelectric element or other such vibrating member at a specific frequency, and converting the Coriolis force into voltage. Any hand shake imparted to the digital camera 1 by the user is corrected by driving a correction lenses inside the OIS's 112 in the direction of canceling out the shake corresponding to this angular velocity information. The gyro sensor 220 may be any device that is capable of at least measuring angular velocity information for a pitch angle. If the gyro sensor 220 is also capable of measuring angular velocity information in the yaw direction, then shake with respect to rotation when the digital camera 1 is moved substantially in the horizontal direction can be canceled out.

The card slot 230 allows the memory card 240 to be inserted. The card slot 230 can be mechanically and electrically connected to the memory card 240.

The memory card 240 includes an internal flash memory, ferroelectric memory, etc., and is able to store data.

“Manipulation member 250” is the collective name of a user interface that receives commands from the user. For example, it may comprise a release button, an enter button, or a cross key that receives commands from the user. A release button is pressed by the user. When the release button is pressed half-way down, AF control and AE control are commenced via the controller 210. When the release button is pressed all the way down, an image of the subject is captured.

The zoom lever 260 is a member that receives change commands of zoom ratio from the user.

The liquid crystal monitor 270 is a display device that is configured to display the first perspective signal and second perspective signal read out from the memory card 240, or the first perspective signal and second perspective signal produced by the CCD image sensors 150, in either 2D or 3D display. Also, the liquid crystal monitor 270 is configured to display various kinds of setting information for the digital camera 1. For example, the liquid crystal monitor 270 display the EV value, the F value, the shutter speed, the ISO sensitivity, or the like, which are imaging conditions during imaging.

In the case of 2D display, the liquid crystal monitor 270 may selectively display either the first perspective signal or the second perspective signal, or may split the display of the first perspective signal and the second perspective signal into right and left or up and down, or may alternately display the first perspective signal and the second perspective signal on different lines.

In the case of 3D display, the liquid crystal monitor 270 may display the first perspective signal and the second perspective signal sequentially in frames, or may display the first perspective signal and the second perspective signal as an overlay.

The mode setting button 290 is used to set the imaging mode during imaging with the digital camera 1. The imaging mode is what indicates the imaging scenes expected by the user. For example, the imaging modes include 2D imaging modes including (1) adult mode, (2) child mode, (3) pet mode, (4) macro mode, and (5) landscape mode, and (6) 3D imaging mode. The imaging modes may also have 3D imaging modes corresponding to each of (1) to (5) above. Further, the imaging modes may have an automatic camera setting mode for automatically setting the imaging mode of the digital camera 1. The digital camera 1 sets suitable imaging parameters and captures an image based on the above-mentioned imaging modes. The mode setting button 290 is used to set a mode for reproducing image signals recorded to the memory card 240 (reproduction mode).

The CCD image sensor 150(a) is an example of a first imaging unit. The CCD image sensor 150(b) is an example of a second imaging unit. The internal memory 280 is an example of a storage unit. A face is an example of a subject, such as part of a subject. The image processor 160 is an example of an identification unit, a parallax information decision unit, and/or a display position decision unit. The controller 210 is one example of a 3D display control unit. The liquid crystal monitor 270 is an example of a 3D display unit.

1-1. Image Signal Imaging Operation

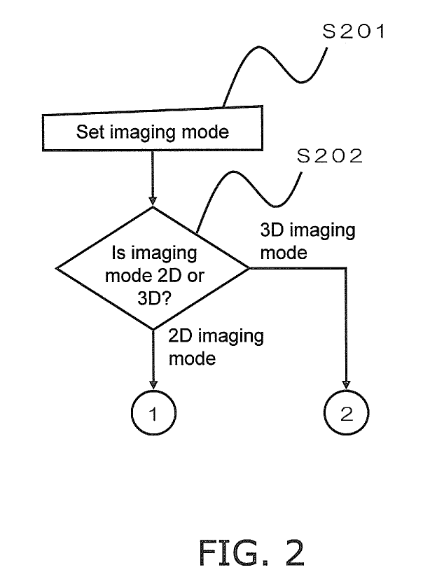

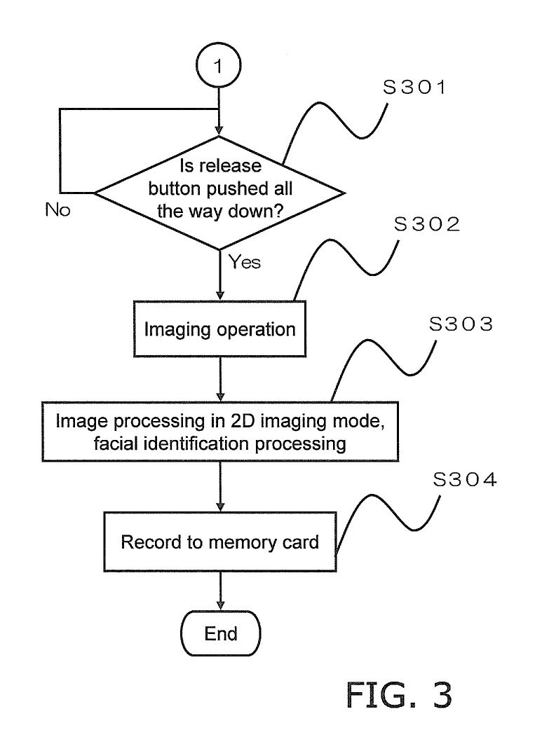

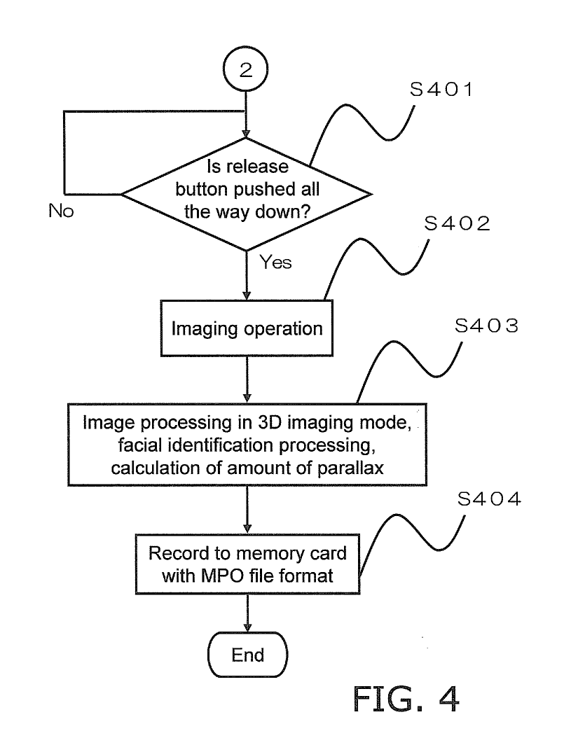

The image signal imaging operation with the digital camera 1 will now be described. FIG. 2 is a flowchart illustrating an image signal imaging operation with the digital camera 1. FIG. 3 is a flowchart illustrating the imaging operation in 2D imaging mode. FIG. 4 is a flowchart illustrating the imaging operation in 3D imaging mode.

As shown in FIG. 2, when the user selects an imaging mode with the mode setting button 290, the controller 210 recognizes the imaging mode (S201). The controller 210 then determines whether or not the imaging mode is a 2D imaging mode or 3D imaging mode (S202). If the imaging mode is a 2D imaging mode, the flow proceeds to step 5301 (see (1) in FIG. 2, and see FIG. 3). On the other hand, if the imaging mode is a 3D imaging mode, the flow proceeds to S401 (see (2) in FIG. 2, and see FIG. 4).

If the imaging mode is a 2D imaging mode, as shown in FIG. 3, the controller 210 waits until the release button is pushed all the way down (No in S301). When the release button is pushed all the way down (Yes in S301), the imaging element of the CCD image sensors 150(a) and/or 150(b) performs an imaging operation based on the imaging conditions set for 2D imaging mode (S302). Here, the imaging elements produce image signals for a first perspective signal and/or a second perspective signal.

Then, the image processor 160 temporarily stores the produced image signals in the memory 200. The image processor 160 then performs facial identification processing for the image signals stored in the memory 200 (S303). Here, the image processor 160 performs various kinds of image processing corresponding to the 2D imaging mode for these image signals, and produces a compressed image signal. The details of the facial identification processing will be discussed below.

Then, the controller 210 records the compressed image signal to the memory card 240 connected to the card slot 230 (S304). If there is a compressed image signal for the first perspective signal and a compressed image signal for the second perspective signal, the controller 210 records the two compressed image signals to the memory card 240 using a JPEG file format for each one. If facial identification is successful, the controller 210 records the position on the image of the identified face, and identification information such as an identification name, associating these with the compressed image signals.

Meanwhile, if the imaging mode is a 3D imaging mode, as shown in FIG. 4, the controller 210 waits until the release button is pushed all the way down (No in S401). When the release button is pushed all the way down (Yes in S401), the imaging element of the CCD image sensors 150(a) and/or 150(b) performs an imaging operation based on the imaging conditions set for 3D imaging mode (S402). Here, the imaging elements produce image signals for a first perspective signal and/or a second perspective signal.

Then, the image processor 160 temporarily stores the produced image signals (first perspective signal and second perspective signal) in the memory 200. Here, the image processor 160 performs facial identification processing for the first perspective signal and second perspective signal stored in the memory 200 (S403). If facial identification is successful, the image processor 160 calculates the amount of parallax for one of the first perspective signal and the second perspective signal with respect to the other of the first perspective signal and the second perspective signal. Here, for example, the image processor 160 calculates the amount of parallax of the first perspective signal with respect to the second perspective signal. More specifically, the image processor 160 calculates the amount of parallax of a facial image included in the first perspective signal (the amount of parallax used for a facial image) with respect to the facial image included in the second perspective signal. Also, here, the image processor 160 performs various kinds of image processing corresponding to 3D imaging mode for the first perspective signal and the second perspective signal, and produces two compressed image signals. The details of the facial identification processing will be discussed below.

Then, the controller 210 records the two compressed image signals to the memory card 240 connected to the card slot 230 (S404). The controller 210 associates and records the two compressed image signals using an MPO file format, for example. If facial identification is successful, the controller 210 records the position on the image of the identified face, the amount of parallax used for the facial image, and identification information such as identification names, associating these with the compressed image signals.

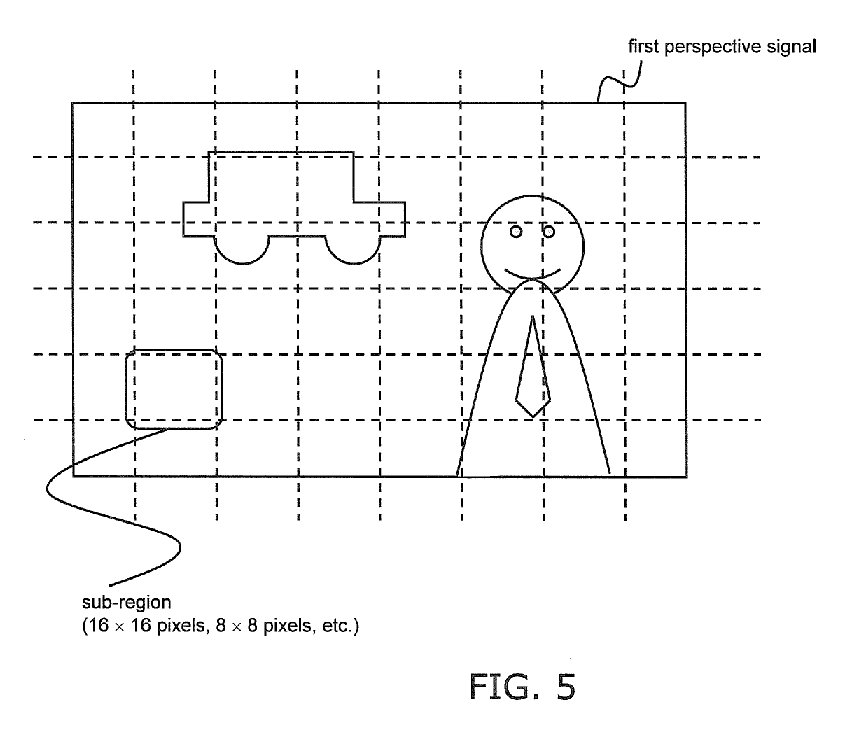

How the amount of parallax is calculated will now be described. FIG. 5 shows how the entire region of an image signal is divided up into sub-regions. As shown in FIG. 5, the image processor 160 divides the entire region of the first perspective signal read from the memory 200 into a plurality of sub-regions, for example. The image processor 160 then uses the sub-regions of the first perspective signal to search for the regions of the second perspective signal corresponding to the sub-regions of the first perspective signal, and calculates the amount of parallax. Specifically, the image processor 160 calculates the amount of parallax in sub-region units.

The number of sub-regions may be set according to the processing load of the digital camera 1. For example, if the processing load of the digital camera 1 is low, control is performed so as to increase the number of sub-regions. Conversely, if the processing load of the digital camera 1 is high, control is performed so as to decrease the number of sub-regions. More specifically, if there is extra processing capacity in the digital camera 1, the amount of parallax is detected in pixel units. On the other hand, if there is no extra processing capacity in the digital camera 1, a 16×16 pixel unit is set as a sub-region, and a single, representative amount of parallax is detected with the sub-region.

An example was given here in which the amount of parallax was calculated by searching for the regions of the second perspective signal corresponding to sub-regions of the first perspective signal. Instead, the amount of parallax may be calculated in sub-region units by dividing the entire region of the second perspective signal into a plurality of sub-regions just as with the first perspective signal.

The amount of parallax is the amount of deviation in the horizontal direction of the second perspective signal with respect to the first perspective signal, for example. In this case, the image processor 160 performs block matching between sub-regions in the first perspective signal and the corresponding regions in the second perspective signal. The image processor 160 calculates the amount of deviation in the horizontal direction based on the result of this block matching, and sets this amount of deviation as the amount of parallax.

1-2. Image Signal Reproduction Operation

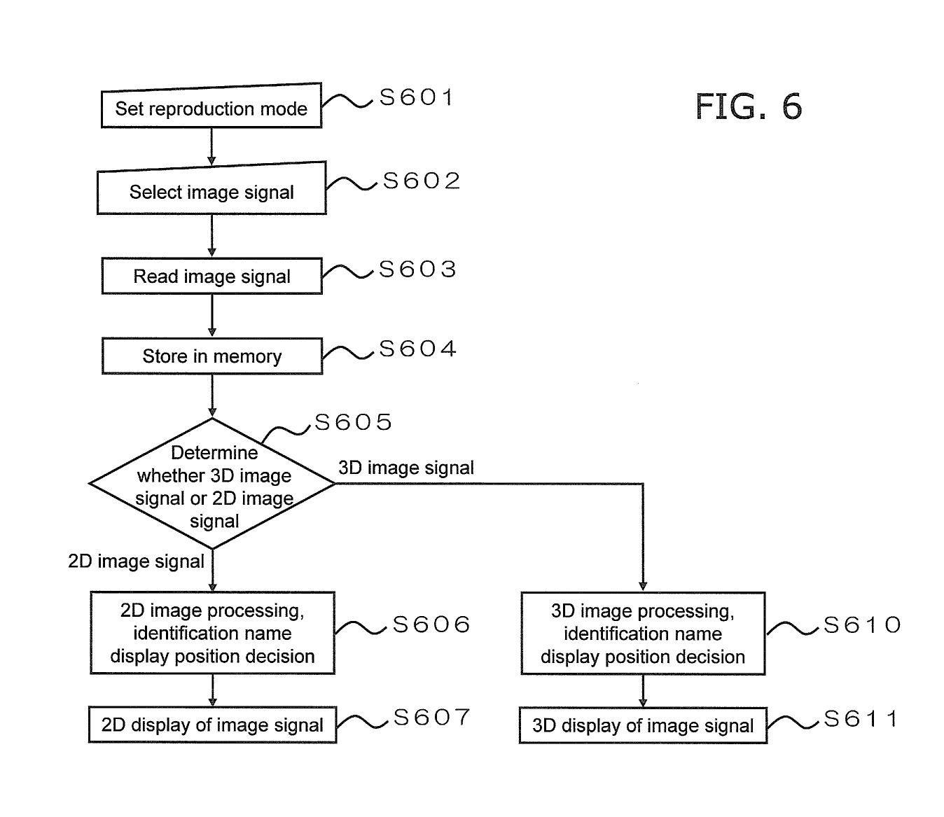

The operation of reproducing a compressed image signal with the digital camera 1 will now be described. FIG. 6 is a flowchart illustrating the reproduction of a compressed image signal with the digital camera 1.

First, when the user operates the mode setting button 290 to set to reproduction mode, the digital camera 1 changes into reproduction mode (S601). Then, the controller 210 reads a thumbnail image of the image signal from the memory card 240, or produces a thumbnail image based on this image signal, to display on the liquid crystal monitor 270. The user selects the image signal that will actually be displayed based on this thumbnail image (S602). If the user selects a specific image signal, the controller 210 reads a compressed image signal corresponding to the selected image signal from the memory card 240 (S603). The controller 210 then records the compressed image signal that was read, to the memory 200 (S604).

The controller 210 then determines whether the compressed image signal recorded to the memory 200 is a 3D image signal or a 2D image signal (S605). For example, if the image signal has an MPO file format, the controller 210 determines this image signal to be a 3D image signal that includes a first perspective signal and a second perspective signal. If the user has inputted ahead of time whether to read with a 2D image signal or with a 3D image signal, the controller 210 makes the above determination based on this inputted information.

If the controller 210 determines that the compressed image signal is a 2D image signal, then the image processor 160 performs 2D image processing (S606). More specifically, the image processor 160 performs decoding processing for the compressed image signal. The image processor 160 may also perform sharpness processing, contour enhancement processing, or other such image processing, for example. Also, if there is identification information, the image processor 160 decides on the identification name display position. The details of deciding on the identification name display position will be discussed below.

Then, if the image processor 160 has performed 2D image processing, the controller 210 displays the image signal that has undergone this 2D image processing on the liquid crystal monitor 270 by 2D-mode (S607). A 2D mode is a display format in which a display is made on the liquid crystal monitor 270 so that a viewer can perceive an image signal as a 2D image. If there is identification information, an identification name is superimposed in the display at the identification name display position decided in step 606 (S606).

On the other hand, if the controller 210 determines that the compressed image signal is a 3D image signal, then the image processor 160 performs 3D image processing on the first perspective signal and the second perspective signal (S610). More specifically, the image processor 160 performs decoding processing on the compressed image signal. For example, the image processor 160 uses a low-pass filter to perform graduation processing. More specifically, the image processor 160 uses a low-pass filter to perform filtering on the pixels in question. The low-pass filter is set to a preset filter coefficient and filter size as desired. In performing the decoding, processing that corresponds to graduation processing may be performed. For example, in the case of a decoding method that makes use of a quantization table, just as JPEG, graduation processing can be performed on the image signal by making the quantization of the high-frequency component less fine. If there is identification information, the image processor 160 decides on the identification name display position. The decision of the identification name display position will be discussed below.

Then, the controller 210 displays the first perspective signal and the second perspective signal that have undergone decoding processing on the liquid crystal monitor 270 by 3D-mode (S611). A 3D-mode is a display format in which a display is made on the liquid crystal monitor 270 so that a viewer can perceive an image signal as a 3D image. An example of a 3D display method is one in which the first perspective signal and the second perspective signal are displayed on the liquid crystal monitor 270 by frame sequential method. If there is identification information, an identification name is superimposed in the display over the first perspective signal and the second perspective signal at the identification name display position decided in step 610 (S610). In this case, the identification name is superimposed over the first perspective signal and the second perspective signal based on the amount of identification name-use parallax decided using the amount of parallax for a facial image as a reference (an example of the amount of identification information-use parallax). The amount of identification name-use parallax will be discussed below.

1-3. Facial Identification Function

The digital camera 1 has a facial identification function. A facial identification function is a function of identifying whether or not the facial images captured by the CCD image sensors 150(a) and 150(b) are the same as a facial image that has already been registered. Facial identification processing is executed in 2D imaging mode and 3D imaging mode. The basic details of this processing is the same in both 2D and 3D imaging mode.

1-3-1. Facial Identification Function in 2D Imaging Mode

The digital camera 1 has a facial identification function in 2D imaging mode. With the digital camera 1, the controller 210 decides whether or not first specification information with respect to a registered facial image is similar to second specification information with respect to a facial image included in the image being captured. If the controller 210 decides that the two pieces of information are similar, then the controller 210 concludes that the registered facial image is the same face as that in the facial image corresponding to the face of the imaged subject.

In imaging a subject with the digital camera 1, the controller 210 identifies whether or not a registered facial image is present in the subject being imaged. If the controller 210 identifies that a registered facial image is present in the subject being imaged, then the digital camera 1 performs operations such as preferentially focusing on the registered face.

Position information about a face that has been successfully identified and identification information such as an identification name and so forth are recorded in the image data for the image for which facial identification has been successful.

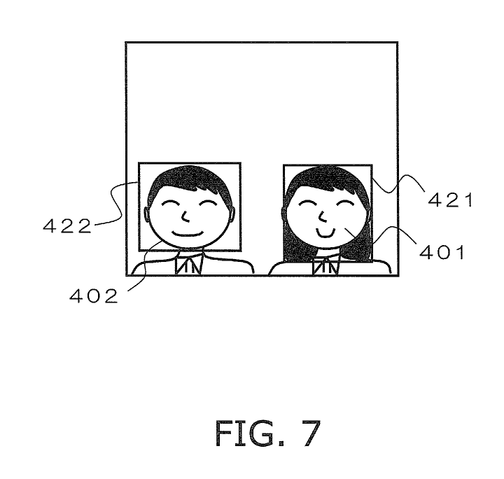

FIG. 7 is a diagram illustrating facial identification imaging in 2D imaging mode. In FIG. 7, information for defining a figure (facial identification box; an example of identification information) that encompasses identified facial images 401 and 402, and information such as identification names are recorded as identification information within the image data during imaging. Here, squares 421 and 422 are used as the facial identification boxes. The squares 421 and 422 are set so that they have their minimum surface area in a state in which they encompass the identified facial images 401 and 402. The information for defining the squares 421 and 422 includes the upper-left end coordinate, the X coordinate width, the Y coordinate width, and so on. Specifically, information such as the upper-left end coordinate, the X coordinate width, the Y coordinate width, and identification names is recorded as identification information within the image data during imaging. Also, the depth direction position of the facial identification boxes, such as the squares 421 and 422, is set based on the amount of facial identification-use parallax (an example of the amount of identification information-use parallax). The setting of the amount of facial identification-use parallax is executed in the same manner as the setting of the identification name display position, that is, the setting of the amount of identification name-use parallax.

1-3-2. Facial Identification Function in 3D Imaging Mode

The digital camera 1 has a facial identification function in 3D imaging mode as well. With the digital camera 1, the controller 210 performs facial identification during imaging. The basic details of the processing are the same as during 2D imaging. Therefore, mainly just the processing that is different from that in 2D imaging mode will be described.

With the facial identification function in 3D imaging mode, the controller 210 performed the identification processing of facial images based on the first perspective signal and the second perspective signal captured by the CCD image sensors 150(a) and 150(b). The controller 210 records position information about the identified facial images, and information related to facial images, such as identification names. Also, the controller 210 calculates and records the amount of parallax with respect to an identified facial image (the amount of facial image-use parallax). Specifically, the controller 210 records position information about the identified facial images, the amount of facial image-use parallax, and identification information such as identification names and so forth.

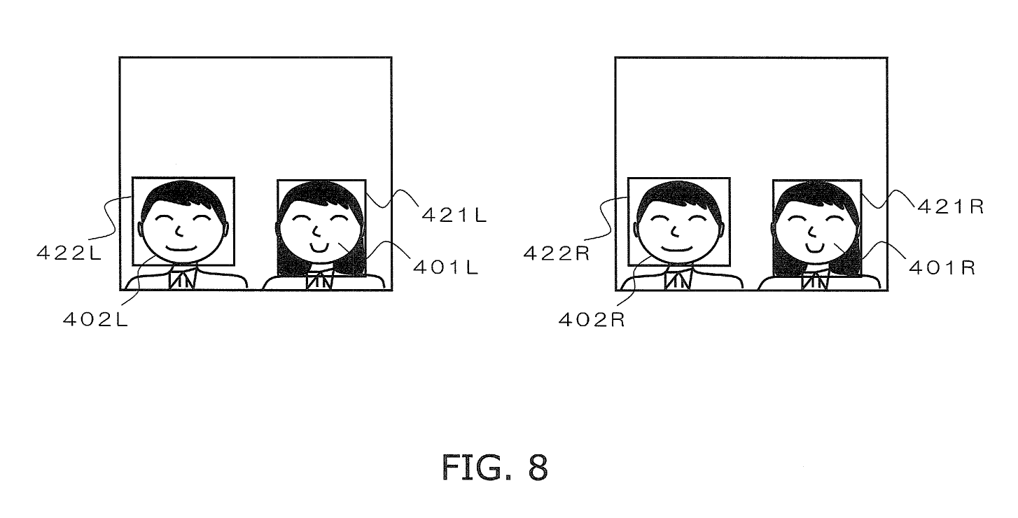

FIG. 8 is a diagram illustrating facial identification imaging in 3D imaging mode. In FIG. 8, the controller 210 records information about the squares 421L and 421R with respect to the facial images 401L and 401R of a person 401, identification information constituting of identification names and the like, and the amount of this identification name-use parallax. Similarly, the controller 210 records information about the squares 422L and 422R with respect to the facial images 402L and 402R of a person 402, identification information constituting of identification names and the like, and the amount of this identification name-use parallax.

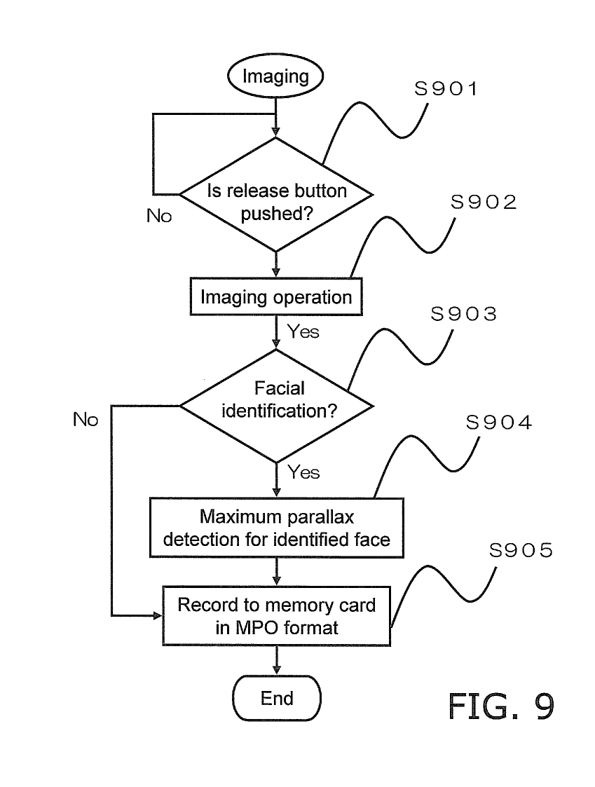

The flow of facial identification processing in 3D imaging mode with the digital camera 1 will now be described. FIG. 9 is a flowchart illustrating the operation of a facial identification function in 3D imaging mode with the digital camera 1.

First, when 3D imaging mode has been selected, the controller 210 waits until the release button is pushed all the way down, just as in 2D imaging mode (No in S901). When the release button is pushed all the way down (Yes in S901), the CCD image sensors 150(a) and 150(b) perform an imaging operation based on the imaging conditions set for 3D imaging mode (S902). Here, the CCD image sensors 150(a) and 150(b) produce a first perspective signal and a second perspective signal.

Then, the image processor 160 temporarily store the two image signals (the first perspective signal and second perspective signal) produced, in the memory 200. The image processor 160 then identifies facial images based on the first perspective signal and the second perspective signal in the memory 200 (S903). The image processor 160 at this point determines whether or not facial identification was successful.

For example, if facial identification was successful for the first perspective signal and/or the second perspective signal, the controller 210 determines that the facial identification was successful (Yes in S903). On the other hand, if facial identification has failed for both the first perspective signal and the second perspective signal, the controller 210 determines that facial identification has failed (No in S903).

Then, if the facial identification was successful in step 903 (S903) (Yes in S903), the image processor 160 detects the maximum amount of parallax for the facial images 402L and 402R based on the first perspective signal and the second perspective signal (S904). Also, the image processor 160 produces a compressed image signal corresponding to the first perspective signal, and a compressed image signal corresponding to the second perspective signal.

Then, the controller 210 records the two compressed image signals, the face position information identified above, the maximum amount of parallax, and the identification information such as the identification name to the memory card 240 connected to the card slot 230 (S905). When the two compressed image signals are recorded to the memory card 240, the two compressed image signals are associated with each other using an MPS file format for the recording, for example.

1-3-3. Facial Identification Function in 3D Reproduction Mode

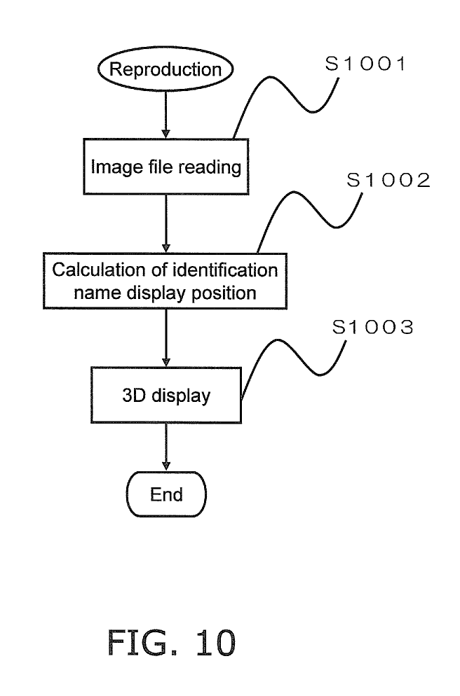

The facial identification function in 3D reproduction mode with the digital camera 1 will now be described. FIG. 10 is a flowchart illustrating the operation of a facial identification function in 3D reproduction mode with the digital camera 1.

First, the controller 210 reads the compressed 3D image signal from the memory card 240 (S1001). For example, if the image signal has an MPO file format, the controller 210 determines that the compressed image signal is a 3D image signal that includes a first perspective signal and a second perspective signal, and reads out this signal.

Next, if identification information is associated with the reproduced image corresponding to the 3D image signal that has been read, then the controller 210 decides on the display position for the identification name (S1002). The identification name is displayed in the vicinity of the face, for example. More specifically, in a two-dimensional plane, the position of the identification name is set so that the identification name will be located above away from the square 421 that includes the identified face. The distance between identification name and the square 421 is a predetermined distance. Therefore, the identification name is displayed above the square 421 that is defined by the position information of the identified face

Also, the position of the identification name is set with respect to the depth direction, which is perpendicular to the two-dimensional plane. For example, the amount of parallax of the identification names is set with respect to the identified face image. As a result, the identification name is displayed so that when the user looks at the reproduced image, the identification name is perceived to be in front of the identified face.

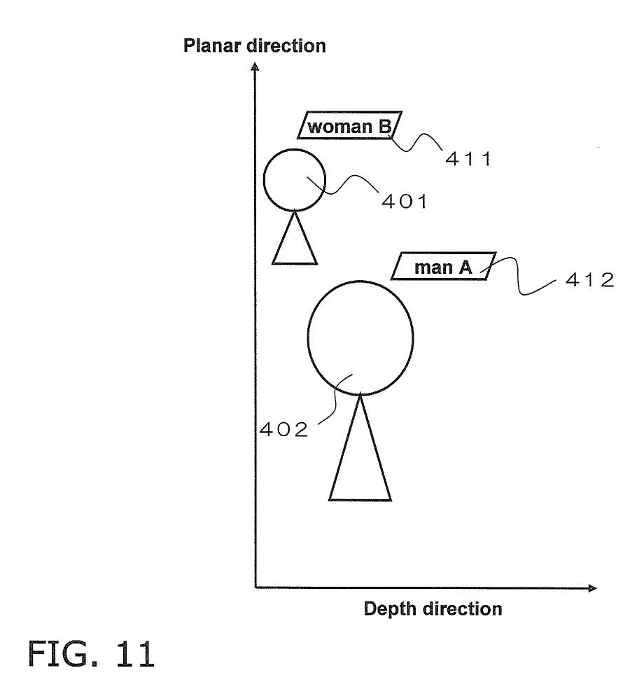

FIG. 11 is a schematic showing the positional relation between an identified face and an identification name. For example, the amount of parallax is defined as the amount of deviation in the horizontal direction of the second perspective signal with respect to the first perspective signal, as discussed above. Here, if we let the first perspective signal be a perspective signal used for the right eye, and the second perspective signal be a perspective signal used for the left eye, then the amount of parallax is the remainder obtained by subtracting the position information in the right-eye perspective signal from the position information in the left-eye perspective signal. In this case, an object having a positive value for the amount of parallax (subtraction remainder) is perceived as being in front of the position where the amount of parallax is zero.

For example, in FIG. 11, the amount of identification name-use parallax is decided so that the amount of parallax of the identification names 411 and 412 (the amount of identification name-use parallax) will be greater than the amount of parallax of the identified facial images 401 and 402 (the amount of facial image-use parallax). Here, the amount of parallax is a signed real number. The greater is the amount of identification name-use parallax, the more the user perceives the identification names 411 and 412 to be in front, using the identified facial images 401 and 402 as a reference.

When the amount of identification name-use parallax is thus set, this decides the display position for the identification name using the position of the facial image 401 as a reference (an example of a first display position), and the display position for the identification name using the position of the facial image 402 as a reference (an example of a second display position). For example, the identification name is displayed at a position having a parallax equivalent to the difference between the amount of facial image-use parallax and the amount of identification name-use parallax, that is, a position that is in front of the identified face (see FIG. 11). The display position of the identification name 411 in the depth direction with respect to the facial image 401 is set independently of the display position of the facial image 402. Also, the display position of the identification name 411 in the depth direction with respect to the facial image 401 may be in front of the position of the facial image 402, so long as it is in front of the facial image 401.

The amount of facial identification box-use parallax is set in the same manner as the amount of identification name-use parallax. Consequently, the facial identification boxes, such as the squares 421 and 422 are perceived by the user to be in front in the 3D image, using the identified facial images 401 and 402 as a reference.

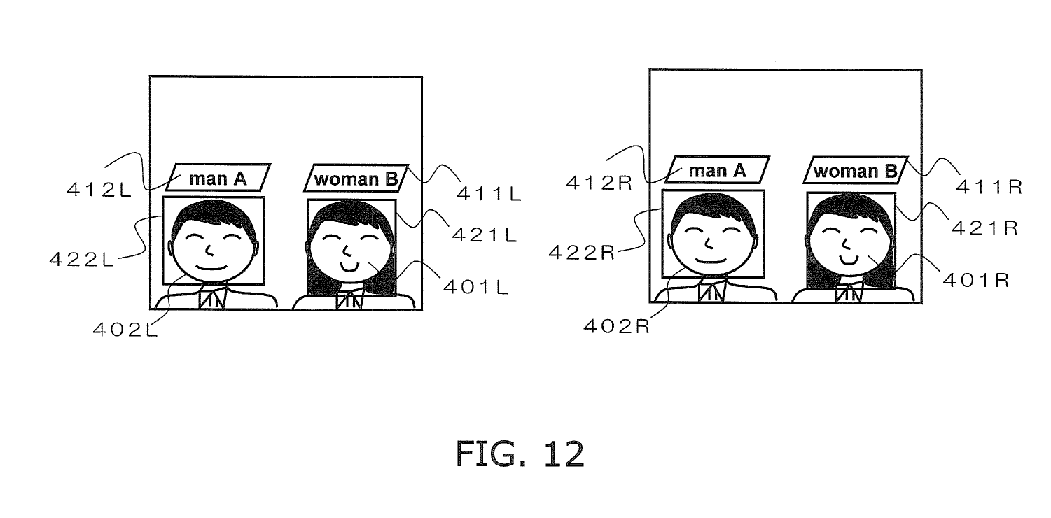

Then, the controller 210 displays a 3D image on the liquid crystal monitor 270 based on the first perspective signal and the second perspective signal (S1003). Also, the controller 210 superimposes figures, such as the squares 421 and 422, that encompass the identified facial images in a two-dimensional plane, over the 3D image corresponding to the first perspective signal and the second perspective signal, as shown in FIG. 8, based on the amount of facial identification box-use parallax. Consequently, the squares 421 and 422 are displayed in 3D in front of the identified facial images 401 and 402. Also, the controller 210 superimposes the identification names 411 and 412 over a 3D image corresponding to the first perspective signal and the second perspective signal based on the amount of identification name-use parallax decided in step S1002. Consequently, as shown in FIG. 12, the identification names 411 and 412 are displayed in 3D in front of the identified facial images 401 and 402.

1-4. Summary

The digital camera 1 in this embodiment comprises the image processor 160 and the controller 210.

The image processor 160 implements an identification unit, a parallax information decision unit, and/or a display position decision unit. The controller 210 implements a 3D display control unit. The liquid crystal monitor 270 implements a 3D display unit.

The image processor 160 is configured to calculate the amount of parallax with respect to a facial image (the amount of facial image-use parallax) based on a first perspective signal and a second perspective signal.

Also, the image processor 160 is configured to set identification name for identifying the facial image. Also, the image processor 160 is configured to output the identification name and the amount of facial image-use parallax.

The image processor 160 also is configured to decide on the amount of identification name-use parallax based on the amount of facial image-use parallax so that the identification name is perceived to be away from the facial image in the depth direction.

Further, the image processor 160 is configured decide on the first display position of the identification name with respect to the first perspective signal, and the second display position of the identification name with respect to the second perspective signal, based on the amount of facial image-use parallax.

The controller 210 is configured to display the identification name superimposed with the first perspective signal at the first display position, and display the identification name superimposed with the second perspective signal at the second display position.

With this constitution, an identification name associated with a face for a 3D image signal can be displayed at a different position from that of the face in the depth direction. For instance, the identification name can be displayed so that it can be perceived to be right in front of the face in the depth direction. Therefore, when the user looks at the displayed image, he can easily perceive the face and the identification name as a pair, without greatly shifting his line of sight in the depth direction.

Also, the digital camera 1 in this embodiment comprises the controller 210. The controller 210 superimposes the identification name over the first perspective signal and superimposes the identification name over the second perspective signal, based on the amount of identification name-use parallax set so that the identification name will be perceived as being at a position away from the facial image in the depth direction.

### Other Embodiments

In the above embodiment, during 3D imaging, facial identification processing was performed, the amount of parallax was found for the identified facial image, and the display position of the identification name was decided on the basis of the amount of parallax during 3D reproduction. However, the timing at which this series of processing is executed is not limited to that in the above embodiment. For example, just facial identification processing may be performed during 3D imaging, and the calculation of the amount of parallax and the decision of the display position of the identification name may be performed during 3D reproduction.

Also, depth information about the face may be used instead of the amount of facial image-use parallax. In a 3D image, information related to depth and the amount of parallax are substantially equal. Accordingly, when depth information is used in place of the amount of parallax, the identification name can be displayed in the same manner as in the above embodiment.

Also, in the above embodiment, an example was given in which facial detection processing was executed by using both a first perspective signal and a second perspective signal, but facial detection processing may also be executed by using just the first perspective signal or the second perspective signal. In this case, for example, during imaging or reproduction, the amount of parallax can be found by searching by blocking matching or the like for the regions of either the first perspective signal or the second perspective signal based on sub-regions of the other of the first perspective signal and the second perspective signal.

Also, processing related to facial identification may not be performed at all during 3D imaging, and instead facial identification processing may be performed during 3D reproduction, and the identification name thus obtained may be superimposed. In other words, the present technology can also be applied to a 3D reproduction device.

In the above embodiment, an example was given in which the result of facial identification was recorded along with an image signal, and the identification name was displayed during reproduction. Alternatively, facial identification may be performed on a captured image signal, and the identification name may be superimposed during live view display (through-image display) or during review display.

In the above embodiment, an example was given in which figures that encompassed a face, such as the squares 421 and 422, were set as the facial identification boxes. Alternatively, figures that encompass an object other than a face, such as the automobile shown in FIG. 5, may be displayed. Also, if the object moves, the figure encompassing this moving object may be displayed as trace boxes that trace the moving object. Also, these trace boxes may be used as a focusing frame. These trace boxes may also be used as identification information, the same as an identification name or a facial identification box. Further, the amount of parallax of the trace boxes may be set so that the amount of parallax of the trace box is greater than the amount of parallax of the moving object, just as with the facial identification box or the identification name in the above embodiment, which allows the user to perceive the trace box as being in front of the moving object.

In the above embodiment, an example was given in which a face was identified from an image signal, and the identification name thereof was displayed, but what is identified is not limited to being a face, and another object may be identified as the subject. In this case, possible objects include animals, plants, and other living things, vehicles, boats, aircraft, and other such moving bodies, bridges, towers, buildings, and other such manmade structures, mountains and other such geological features, and so forth. Also, just a part of the one of the objects listed here may be used, such as the license plate of a vehicle, or the face of an animal.

With the digital camera described in the above embodiment, the various blocks of digital processing may be handled by a single chip in a semiconductor device such as an integrated circuit, or may be handled by a single chip so as to include all or part of the processing.

Also, the various processing in the above embodiment may be realized by hardware or by software. Furthermore, it may be realized by mixed processing with both software and hardware. When the digital camera pertaining to the above embodiment is realized by hardware, it should go without saying that the timing at which the various processing is performed must be adjusted. In the above embodiment, details about adjusting the timing of the various kinds of processing that occurs in actual hardware design are omitted for the sake of simplicity.

Also, the order in which the processing is executed in the above embodiment is not limited to what is given in the above embodiment, and the execution order can be modified without departing from the gist of the technology.

Furthermore, the specific constitution of the present technology is not limited to or by the embodiment above, and various modifications and improvements are possible without departing from the gist of the technology.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a 3D imaging device and a 3D reproduction device. Accordingly, these terms, as utilized to describe the present technology should be interpreted relative to a 3D imaging device and a 3D reproduction device.

The term “configured” as used herein to describe a component, section, member or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technology are provided for illustration only, and not for the purpose of limiting the technology as defined by the appended claims and their equivalents.

### INDUSTRIAL APPLICABILITY

The art herein disclosed is useful as a 3D imaging device and a 3D reproduction device.

What is claimed is:

1. A 3D imaging device configured to display a 3D image of a subject that is based on a first image signal and a second image signal which constitutes a 3D image signal, the 3D imaging device comprising:
an identification unit configured to calculate first parallax information for an object image that corresponds to the subject based on the first and second image signals, the identification unit being further configured to set identification information that identifies the object image and to output the first parallax information and the identification information;
a parallax information decision unit configured to decide on second parallax information for the identification information based on the first parallax information so that the identification information is visually recognizable at a depth separate from the object image;
a display position decision unit configured to decide on first and second display positions of the identification information, the first display position being chosen with respect to the first image signal, and the second display position being chosen with respect to the second image signal, selection of the first and second display positions being based on the second parallax information; and
a 3D display control unit coupled to at least one of the identification unit, the parallax information decision unit, and the display position decision unit, the 3D display control unit being configured to display the identification information at the first and second display positions, at the first display position the identification information being superimposed on the first image signal, and at the second display position the identification information being superimposed on the second image signal.

2. The 3D imaging device according to claim 1, further comprising
a memory unit operatively coupled to the 3D display control unit and configured to store first specification information that identifies the subject,
wherein the identification unit is configured to extract second specification information that identifies the object image, and to recognize the object image as an image that corresponds to the subject based on the first specification information and the second specification information.

3. The 3D imaging device according to claim 2, wherein
the first specification information identifies at least part of the subject, and the second specification information identifies the object image that corresponds to the at least part of the subject.

4. The 3D imaging device according to claim 1, wherein
the parallax information decision unit is configured to decide on the second parallax information based on the first parallax information so that the identification information is disposed in front of the object image.

5. The 3D imaging device according to claim 1, wherein
the parallax information includes the amount of parallax of either the first image signal or the second image signal with respect to the other of the first image signal and the second image signal.

6. The 3D imaging device according to claim 1, wherein
the identification information includes identification names to identify the object image.

7. A 3D reproduction device configured to reproduce a 3D image of a subject that is based on a first image signal and a second image signal which constitutes a 3D image signal, the 3D reproduction device comprising:
a 3D display control unit configured to display identification information superimposed on the first and second image signals based on second parallax information for the identification information, the second parallax information being set such that the identification information is visually recognizable at a depth separate from the object image, the identification information identifying the object image that corresponds to the subject.

8. The 3D reproduction device according to claim 7, further comprising
a parallax information decision unit operatively coupled to the 3D display control unit and configured to decide on second parallax information based on first parallax information for the object image that corresponds to the subject so that the identification information is visually recognizable at a depth separate from the object image.

9. The 3D reproduction device according to claim 7, further comprising
a display position decision unit operatively coupled to the 3D display control unit and configured to decide on first and second display positions of the identification information, the first display position being chosen with respect to the first image signal, and the second display position being chosen with respect to the second image signal, selection of the first and second display positions being based on the second parallax information,
wherein the 3D display control unit is configured to display the identification information at the first and second display positions, at the first display position the identification information is superimposed on the first image signal, and at the second display position the identification information is superimposed on the second image signal.

10. The 3D reproduction device according to claim 7, further comprising
an identification unit operatively coupled to the 3D display control unit and configured to calculate the first parallax information based on the first and second image signals, the identification unit being further configured to set the identification information and to output the first parallax information and the identification information.
